(19) United States
(12) Patent Application Publication
(10) Pub. No.: US 2023/0095099 A1
(43) Pub. Date: Mar. 30, 2023

(54) Vehicle-To-Vehicle Line-Of-Sight Communications

(71) Applicant: Motional AD LLC, Boston, MA (US)

(72) Inventors: Christopher Konopka, Peabody, MA (US); Adam-Ridgely Khaw, Roslindale, MA (US); Linh Hong Pham, Cambridge, MA (US)

(21) Appl. No.: 17/490,463

(22) Filed: Sep. 30, 2021

(51) Int. Cl. G05D 1/02; G08G 1/09; G08G 1/00; G07C 5/00

(52) U.S. Cl. CPC G05D 1/0293; G08G 1/09; G08G 1/22; G05D 1/028; G07C 5/008

(57) ABSTRACT

Provided are methods and systems for establishing a line-of-sight (LoS) communications link between a first vehicle and one or more second vehicles. The LoS communications link can include a Li-Fi communications link, visible light communications (VLC) link, or other light-based communications link. LoS communications can be used to create and control caravans of vehicles.

### BACKGROUND

Light Fidelity or Li-Fi is a wireless communication technology that uses light to transmit data and position between devices. Li-Fi is a Visible light communication (VLC) technique for sharing data. Li-Fi supports data rates that can transmit audio, video, and multimedia services using light.

### SUMMARY

Systems and methods are described for establishing a line-of-sight (LoS) communications link between a first vehicle and one or more second vehicles. LoS communications can be used to create LoS networks of vehicles, and in some cases create and control caravans of vehicles. LoS communications can include Li-Fi communications systems, VLC communications systems, or other light-based communications systems.

In an embodiments, a method performed by a first vehicle includes detecting, using a perception system on the first vehicle operating in an environment, a second vehicle operating in the environment. The first vehicle can include a perception system, which can include cameras, RADAR, Lidar, etc. The first vehicle can detect a friendly vehicle based on an authentication protocol. The method can also include adjusting, using a control system on the first vehicle, a trajectory of the first vehicle to form a caravan with the second vehicle. Adjusting the trajectory of the first vehicle to form the caravan with the second vehicle includes transmitting data to cause the first vehicle to move to a position such that the second vehicle is within a line-of-sight of at least one line-of-sight communication system of the first vehicle. For example, a caravan is formed when the two vehicles are linked through a handshake process. In some embodiments the pace car manages remote communications between the first vehicle and a command center through a wireless communications protocol. The first vehicle may or may not direct vehicles to adjust their trajectories—vehicles can adjust their own trajectories autonomously.

In some embodiments, adjusting the trajectory of the first vehicle to form the caravan with the second vehicle can include adjusting the trajectory of the first vehicle to move the first vehicle to a position within one car-length of the second vehicle. For example, the distance between cars in the caravan should be no greater than a car length or a diagonal of a car length.

Some embodiments can include performing, using the line-of-sight communications system, a handshake procedure with the second vehicle. For example, the handshake is how the communication link between vehicles is established. The vehicle can transmit, using a radio communication system, the results of the handshake procedure to a remote command center for validation.

Some embodiments can include receiving, using the radio communication system, a handshake validation message from the remote command center. For example, radio communication system is whatever system the vehicle uses to communicate with the command center or FAS. The vehicle can also establish, using the line-of-sight communication system, a communications link with the second vehicle by opening an LoS channel between the vehicles. For example, the LoS communication system is Li-Fi system, VLC system, or other light-based communication system. The communications link can be a Li-Fi link.

Some embodiments can also include receiving, using the radio communication system, information from the remote command center. For example, pace car is the hub between command center and other vehicles in the caravan, so the pace car receives whatever information the command center is sending. The first vehicle can also transmit, using the line-of-sight communication system, the information to the second vehicle. For example, then the pace car send that information to the other vehicles in the caravan using the Li-Fi or VLC.

In some embodiments, the information comprises one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle. The command center can receive information to one or more second vehicles through the first vehicle's Li-Fi link, such vehicle identification information, status and vital information, route information, origin and destination information, HMI/UX preferences, cargo and manifest information, vehicle capability information, etc.

Some embodiments can include synchronizing, using the line-of-sight communication system, a driving pattern of the first vehicle and the second vehicle based on a selected caravan form factor. For example, this is an example use case for the Li-Fi is where driving patterns are synchronized.

Some embodiments can include synchronizing, using the line-of-sight communication system, a human-machine interface (HMI) scheme of the first vehicle and the second vehicle. For example, another example use case for the Li-Fi is where the HMI scheme can be synchronized.

Some embodiments can include receiving, using the line-of-sight communication system, traffic pattern information from the second vehicle. For example, the caravan can act as a surveyor of traffic patterns, so the second car can send traffic pattern information to the pace car, and the pace car can send that information to the command center and/or to other vehicles in the caravan. The method can also include transmitting, using the radio communication system, the traffic pattern information to the remote command center.

Some embodiments can also include receiving, using the line-of-sight communication system, an indication that the second vehicle is to depart the caravan. For example, there are mechanisms to alter the caravan, particularly when a vehicle leaves. The method also including terminating the communication link with the second vehicle and transmitting, using the radio communication system, a vehicle departure message to the remote command system. For example, the LoS or VLC link is terminated when the second car leaves the caravan. In some embodiments, a pace car can maintain vehicle information for reconnecting the LoS communications link if a departing vehicle is within a certain area around the pace car. In one example, the pace car can establish a geofence. A geofence is a virtual fence or perimeter around a physical location—in this case, around the pace car. If a second vehicle is disconnected from the LoS communications link but remains within the geofence, the pace car can maintain information about the second vehicle until the vehicle departs the geofence or an line-of-sight communications link is reestablished.

In some embodiments, the first vehicle is designated as a pace car for the caravan. Some embodiment can include determining, using a planning system on the first vehicle, that the first vehicle is to depart the caravan. For example, the pace car will have a planned route and corresponding trajectories, so it should know when it needs to depart the caravan. Embodiments can include transmitting, using the radio communication system, a pace car departure message to the remote command center. For example, the pace car alerts the command center that is intends to leave the caravan. Embodiments can include receiving, using the radio communication system, a pace car assignment message indicating that the second vehicle is to become the pace car. For example, the command center assigns a new pace car. Embodiments can include transmitting, using the line-of-sight communication system, the pace car assignment message to the second vehicle. For example, pace car alerts another vehicle that it will become pace car. Embodiments can include terminating the communication link with the second vehicle. Embodiments can include adjusting, using the control system on the first vehicle, a position of the first vehicle to move the first vehicle out of the caravan. For example, the pace care then departs caravan.

In some embodiments, the first vehicle is designated as a pace car for the caravan and the second vehicle is designated as a back-up pace car. Some embodiments can include determining, using a planning system on the first vehicle, that the first vehicle is to depart the caravan. For example, the pace car will have a planned route and corresponding trajectories, so it should know when it needs to depart the caravan. Embodiments can include transmitting, using the line-of-sight communication link, a pace car departure message to the back-up pace car that the pace car is going to depart the caravan. For example, the back-up pace car is alerted that it will become new pace car—back-up pace car should then initiate procedure to establish LoS with other cars as pace care and establish radio link with command center, as described above. Embodiments can include transmitting, using the radio communication system, a pace car departure message to the remote command center. The pace car still alerts the command center that it is departing. Embodiments can include terminating the communication link with the back-up pace car and adjusting, using the control system on the first vehicle, a position of the first vehicle to move the first vehicle out of the caravan.

In some embodiments, a first vehicle can include a perception system including circuitry to detect a second vehicle, and determine that the second vehicle is compatible with the first vehicle to form a caravan. The first vehicle can include a control system including circuitry to move the first vehicle to become within a line-of-sight of the second vehicle. The first vehicle can include an LoS communication system to establish a line-of-sight communication link with the second vehicle. The first vehicle can include a radio communication system to establish a radio communication link with a remote command center. The control system can adjust the trajectory of the first vehicle to move the first vehicle to a position within one car-length of the second vehicle to form a caravan. The LoS communications system can include a Li-Fi system, a VLC system, or other light-based communications system.

In some embodiments, a first vehicle can include at least one computer-readable medium storing instructions. The first vehicle can include an LoS communication system. The first vehicle can include at least one processor to execute the instructions, the execution carrying operations including detecting a second vehicle, determining that the second vehicle is compatible with the first vehicle to form a caravan, moving the first vehicle to become within a line-of-sight of the second vehicle, establishing a line-of-sight communication link with the second vehicle, establishing a radio communication link with a remote command center, and adjusting the trajectory of the first vehicle to move the first vehicle to a position within one car-length of the second vehicle to form a caravan. The LoS communications system can include a Li-Fi system, a VLC system, or other light-based communications system.

In some embodiments, the line-of-sight communication system can transmit a handshake initiation message to the second vehicle, and receive a handshake acknowledgement message from the second vehicle. The radio communication link can transmit the results of the handshake procedure to a remote command center for validation.

In some embodiments, the radio communication system includes can receive a handshake validation message from the remote command center; and the line-of-sight communication system includes can establish a communications link with the second vehicle.

In some embodiments, the radio communication system can receive information from the remote command center; and the line-of-sight communication system can transmit the information to the second vehicle.

In some embodiments, the information includes one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

In some embodiments, the line-of-sight communication system can transmit information to the second vehicle to synchronize a driving pattern of the first vehicle and the second vehicle.

In some embodiments, the line-of-sight communication system can transmit information to the second vehicle to synchronize a human-machine interface (HMI) scheme of the first vehicle and the second vehicle.

In some embodiments, the line-of-sight communication system can receive traffic pattern information from the second vehicle; and the radio communication system can transmit the traffic pattern information to the remote command center.

In some embodiments, the line-of-sight communication system can receive an indication that the second vehicle is to depart the caravan, and terminate the communication link with the second vehicle. The radio communication system can transmit a vehicle departure message to the remote command system.

In some embodiments, the first vehicle is designated as a pace car for the caravan, the first vehicle comprising a planning system can determine that the first vehicle is to depart the caravan. The radio communication system can transmit a pace car departure message to the remote command center and receive a pace car assignment message indicating that the second vehicle is to become the pace car. The line-of-sight communication system can transmit the pace car assignment message to the second vehicle, and terminate the communication link with the second vehicle. The control system can adjust a position of the first vehicle to move the first vehicle out of the caravan.

In some embodiments, the first vehicle is designated as a pace car for the caravan and the second vehicle is designated as a back-up pace car; the first vehicle including a planning system can determine that the first vehicle is to depart the caravan; the radio communication system can transmit a pace car departure message to the remote command center. The line-of-sight communication link can transmit a pace car departure message to the back-up pace car that the pace car is going to depart the caravan, and terminating the communication link with the back-up pace car. The control system can adjust a position of the first vehicle to move the first vehicle out of the caravan.

In some embodiments, the line-of-sight communication system comprises at least one of an optical emitter and receiver, a Li-Fi system, a visual light communications (VLC) system, or an LED.

In some embodiments, a vehicle caravan includes a primary vehicle operating in an environment; and a secondary vehicle operating in the environment. The primary vehicle is proximate the secondary vehicle, the primary vehicle to control a trajectory of the secondary vehicle using a line-of-sight communication system.

In some embodiments, the primary vehicle is positioned to be in a line-of-sight of the secondary vehicle. In some embodiments, the primary vehicle is positioned within one car length of the secondary vehicle.

In some embodiments, the primary vehicle and the secondary vehicle are in one of a same lane or adjacent lanes.

In some embodiments, the primary vehicle and the secondary vehicle operate using synchronized trajectories.

In some embodiments, the primary vehicle and the secondary vehicle operate using synchronized human-machine interfaces.

In some embodiments, the primary vehicle comprises a radio-wave-based communication system to communicate with a remote command center. The primary vehicle can receive vehicle trajectory information from the remote command center using the radio-wave-based communication system, and transmit vehicle trajectory information to the secondary vehicle using the line-of-sight communication system.

In some embodiments, the line-of-sight communication system includes at least one of a Li-Fi system, a laser-based communication system, a visual light communication system, a light-emitting diode-based communication system, or line-of-sight communication system.

In some embodiments, the primary vehicle includes a global positioning system (GPS), and the primary vehicle establishes a geofence around the secondary vehicle using the GPS.

In some embodiments, the primary vehicle detects a departure of the secondary vehicle based on the secondary vehicle exiting the geofence.

In some embodiments, the primary vehicle or the secondary vehicle detects entry of a third vehicle based on the third vehicle entering the geofence.

In some embodiments, the primary vehicle forms a caravan with the secondary vehicle by detecting, using a perception system, the secondary vehicle; determining, using the perception system, that the secondary vehicle is compatible for forming a caravan; positioning, using a control system, the primary vehicle to become within line-of-sight of the secondary vehicle; transmitting, using the line-of-sight communication system, an encrypted handshake message to the secondary vehicle; receiving, using the line-of-sight communication system, a handshake acknowledgement message; transmitting, using a radio-wave-based communication system, a handshake verification request message to a remote command center; receiving, using the radio-wave-based communication system, a handshake verification message from the remote command center; and establishing, using the line-of-sight communication system, a communication link between the primary vehicle and the secondary vehicle.

In some embodiments, the secondary car includes a perception system to detect objects along a trajectory; the secondary car to transmit, using a line-of-sight communication system, information about perceived objects along the trajectory to the primary vehicle; the primary vehicle to adjust, using a planning circuit, the trajectory of the primary vehicle or the secondary vehicle or both; and the primary vehicle to transmit, using the line-of-sight communication system, trajectory adjustment information to the secondary vehicle.

In some embodiments, a command center system includes a radio-wave-based communication system to transmit information to a vehicle, a memory for storing instructions; and one or more hardware processors to execute instructions to carry out operations. The operations include receiving, using the radio-wave-based communication system, an encrypted handshake validation request message from a primary vehicle, the handshake validation request message for a handshake procedure performed by a primary vehicle and a secondary vehicle to form a caravan; and transmitting, to a primary vehicle using the radio-wave-based communication system, a handshake validation response message validating the handshake procedure between the primary vehicle and the secondary vehicle, the handshake validation response message facilitating the formation of the caravan.

In some embodiments, the operations include transmitting, to the primary vehicle, using the radio-wave-based communication system, vehicle control information pertaining to the secondary vehicle.

In some embodiments, the operations include transmitting, to the primary vehicle, using the radio-wave-based communication system, vehicle interface information pertaining to one or both of the primary vehicle or the secondary vehicle.

In some embodiments, the operations include receiving, from the primary vehicle, using the radio-wave-based communication system, vehicle diagnostics information pertaining to the secondary vehicle; and transmitting, to the primary vehicle, using the radio-wave-based communication system, vehicle system correction information for the secondary vehicle based on the diagnostic information.

In some embodiments, the operations include receiving, from the primary vehicle, using the radio-wave-based communication system, traffic pattern information or roadway obstruction information for a route being traversed by the caravan; determining, using at least one processor, an alternative route information for the caravan based on at least one of the traffic pattern information or the roadway obstruction information; and transmitting, to the primary vehicle, using the radio-wave-based communication system, the alternative route information for the caravan.

Some embodiments include a first vehicle that includes one or more processors, one or more sensors, a line-of-sight (LoS0 communication system, and one or more data storage devices including instructions that when executed by the one or more processors, cause the first vehicle to perform functions including detecting a second vehicle, determining that the second vehicle is compatible with the first vehicle to form a caravan; moving the first vehicle to become within a line-of-sight of the second vehicle; establishing a line-of-sight communication link with the second vehicle; establishing a radio communication link with a remote command center; and adjusting the trajectory of the first vehicle to move the first vehicle to a position within one car-length of the second vehicle to form a caravan.

In some embodiments, the functions include transmitting a handshake initiation message to the second vehicle, receiving a handshake acknowledgement message from the second vehicle, and transmitting the results of the handshake procedure to a remote command center for validation.

In some embodiments, the functions include receiving a handshake validation message from the remote command center and establishing the LoS communications link with the second vehicle.

In some embodiments, the functions include receiving information from the remote command center and transmitting the information to the second vehicle using the LoS communications link.

In some embodiments, the information includes one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

In some embodiments, the functions include transmitting information to the second vehicle using the LoS communications link to synchronize a driving pattern of the first vehicle and the second vehicle.

In some embodiments, the functions include transmitting information to the second vehicle using the LoS communications link to synchronize a human-machine interface (HMI) scheme of the first vehicle and the second vehicle.

In some embodiments, the functions include receiving traffic pattern information from the second vehicle using the LoS communications link and transmitting the traffic pattern information to the remote command center.

In some embodiments, the functions include receiving using the LoS communications link an indication that the second vehicle is to depart the caravan and terminating the LoS communication link with the second vehicle. The functions can also include transmitting a vehicle departure message to the remote command system.

In some embodiments, the first vehicle is designated as a pace car for the caravan, the functions including determining that the first vehicle is to depart the caravan; transmitting a pace car departure message to the remote command center, receiving a pace car assignment message indicating that the second vehicle is to become the pace car, transmitting the pace car assignment message to the second vehicle using the LoS communications link, terminating the LoS communication link with the second vehicle, and adjusting a position of the first vehicle to move the first vehicle out of the caravan.

In some embodiments, the first vehicle is designated as a pace car for the caravan and the second vehicle is designated as a back-up pace car; the functions comprising a determining that the first vehicle is to depart the caravan, transmitting a pace car departure message to the remote command center, transmitting, using the LoS communications link, a pace car departure message to the back-up pace car that the pace car is going to depart the caravan, terminating the LoS communication link with the back-up pace car, and adjusting a trajectory or position of the first vehicle to move the first vehicle out of the caravan.

In some embodiments, the line-of-sight communication system comprises at least one of an optical emitter and receiver, a Li-Fi system, a visual light communications (VLC) system, or an LED.

### BRIEF DESCRIPTION OF THE FIGURES

FIG. 1 is an example environment in which a vehicle including one or more components of an autonomous system can be implemented in accordance with embodiments of the present disclosure.

FIG. 2 is a diagram of one or more systems of a vehicle including an autonomous system in accordance with embodiments of the present disclosure.

FIG. 3 is a diagram of components of one or more devices and/or one or more systems of FIGS. 1 and 2 in accordance with embodiments of the present disclosure.

FIG. 4 is a diagram of certain components of an autonomous system in accordance with embodiments of the present disclosure.

FIG. 5 is a schematic diagram of a vehicle with a line-of-sight communication system in accordance with embodiments of the present disclosure.

FIGS. 6A-C are diagrams of a vehicle establishing a line-of-sight communications link with another vehicle in accordance with embodiments of the present disclosure.

FIGS. 7A-D are diagrams of an implementation of an architectural process for vehicle-to-vehicle line-of-sight communications in accordance with embodiments of the present disclosure.

FIGS. 8A-E are diagrams of example caravan patterns in accordance with embodiments of the present disclosure.

FIGS. 9A-C are diagrams of example surveyor patterns in accordance with embodiments of the present disclosure.

FIG. 10 is a process flow diagram for a vehicle to establish a line-of-sight communications link with another vehicle in accordance with embodiments of the present disclosure.

FIG. 11 is a process flow diagram for a second vehicle to depart a caravan in accordance with embodiments of the present disclosure.

FIG. 12 is a process flow diagram for a pace car to depart a caravan in accordance with embodiments of the present disclosure.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, components, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. Hardware Overview

3. Architecture Overview

4. Architecture Process Flows for Vehicle-to-Vehicle LoS Communications

5. Vehicle Travel Patterns

6. Process Flows

1. General Overview

When vehicle, such as an autonomous vehicle (AV), is traversing an operating environment, one way to get an understanding of the state of the vehicle is through a remote command center. This disclosure describes using line-of-sight (LoS) communication devices of a vehicle to allow the vehicle to communicate with other vehicles using light as a medium. LoS communication allows AVs to interlink and share data via local-link (individual AVs) or over-the-air via cellular connections. LoS communications provide a way for the Human-Machine interface (HMI) to be locally and remotely controlled or sequenced. LoS communications also facilitates AVs to create “caravan” patterns for streamlined travel and for surveying purposes.

Line-of-sight communication systems, such as Li-fi or visible light communication (VLC) systems, are used to communicate vehicle status information between vehicles on the road. In some aspects of the embodiments, a primary vehicle (or pace car) in a formation of vehicles (e.g., a “caravan”) can establish a LOS communications link with secondary vehicles in the formation. Also, secondary vehicles can establish LOS communications with each other and local infrastructure (e.g., secondary vehicles on outside of formation may communicate with traffic lights, 5G edge servers, etc.). The primary vehicle can also communicate with a remote command center using known communications techniques (e.g., Internet, 5G network). The primary vehicle can relay information between the command center and the secondary vehicles either directly or through one or more of the secondary vehicles (e.g., by forming a relay network and/or other types of mesh networks). In one non-limiting example, the primary vehicle and the secondary vehicle can establish a formation of vehicles within a geofence that share information, streamline travel, and otherwise work together to arrive at a destination safely and efficiently.

Vehicles entering and leaving the geofence are tracked by the primary vehicle so that LOS communications and formation patterns can be adjusted in response to the acquisition or loss of a secondary vehicle from the formation. Also, each secondary vehicle can become the primary vehicle in the event the primary vehicle becomes disabled and can no longer perform the communication functions of the primary vehicle. For example, a second vehicle can become the primary vehicle based on any suitable criteria (e.g., its communication capabilities, proximity to the center of the formation). One or more secondary vehicles in the formation then adjust their respective positions in the formation to allow the new primary vehicle to occupy, e.g., the center position of the formation.

Advantages: LOS communication techniques can be encrypted and used in electromagnetically sensitive areas without losing signal pathways, resulting in safer operation of automated vehicles in such electromagnetically sensitive areas. Also, LOS communications between AVs can natively take into account optical transmission mobility and issues with artificial/ambient light miscues, resulting in faster, more precise, and more secure communications between vehicles, which facilitates the creation and maintenance of caravans of vehicles. Caravans can share information about road conditions, traffic patterns, energy usage, stopping points, etc. Caravans can also facilitate drafting of vehicles to conserve energy. The creation of caravans has the added advantage of establishing common communication link to a command center so a single vehicle can act as a communication gateway between the control center and the other vehicles in the caravan. This common communication link can save processing power for vehicles while also speeding up the delivery and processing of information and control signals.

2. Hardware Overview

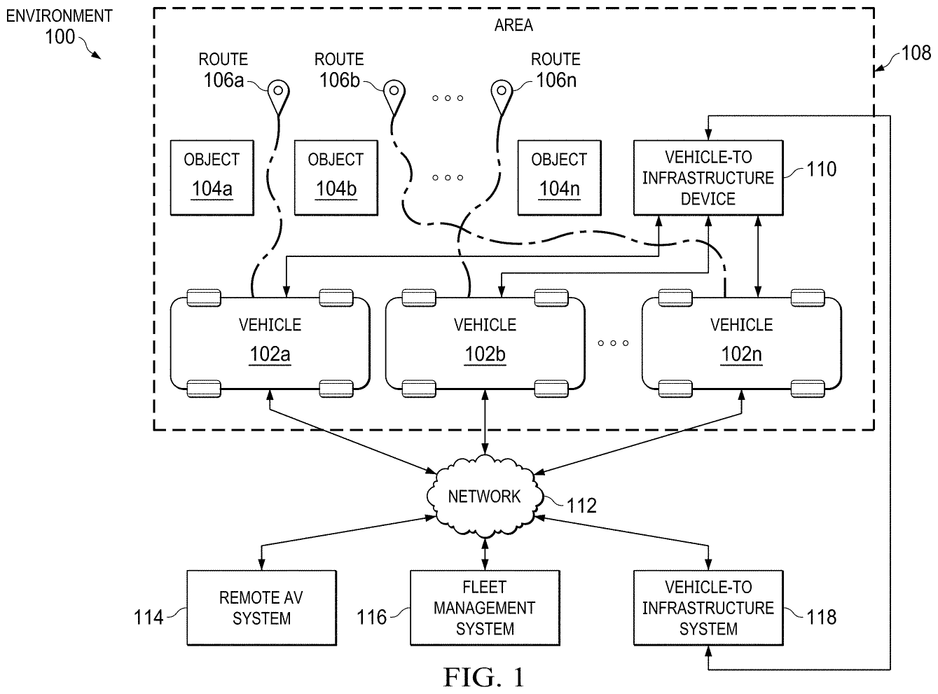

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

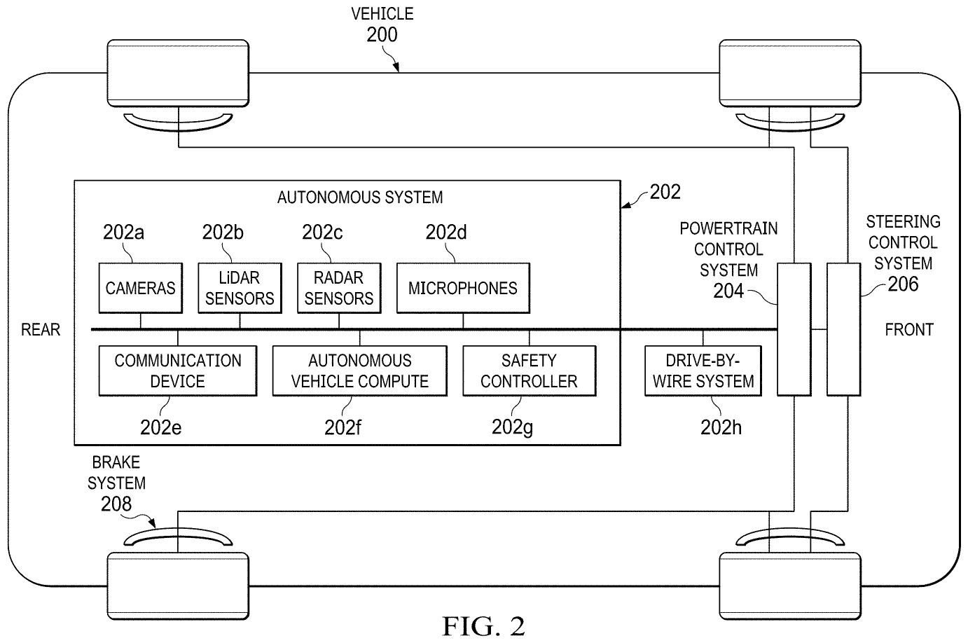

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like. In some embodiments, network 112 supports an autonomy service, such as a fleet autonomy service (FAS) supported by cloud-based services.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle. In some embodiments, the remote AV system 114 can act as a command center for the AV. For example, remote AV system 114 can include a radio-wave-based communication system to transmit information to a vehicle. The radio-wave-based communication system can include hardware and software to encode data packets for transmission on wired and wireless communications protocols, such as cellular protocols. The remote AV system 114 can include a memory for storing instructions and information. The remote AV system 114 can include one or more hardware processors to execute instructions to carry out operations, such as receiving, using the radio-wave-based communication system, an encrypted handshake validation request message from a primary vehicle, the handshake validation request message for a handshake procedure performed by a primary vehicle and a secondary vehicle to form a caravan; and transmitting, to a primary vehicle using the radio-wave-based communication system, a handshake validation response message validating the handshake procedure between the primary vehicle and the secondary vehicle, the handshake validation response message facilitating the formation of the caravan.

As an illustrative example, vehicle 102b can be a first vehicle and be designated as a pace car. Vehicle 102b can communicate with remove AV system 114 (which can serve as a command center) across network 112. Vehicle 102b can establish an LoS communications link with vehicle 102a. Using the LoS communications link, vehicle 102b can relay information to and from the command center to vehicle 102a. Vehicles 102a and 102b can also form a caravan, which is described in more detail below.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

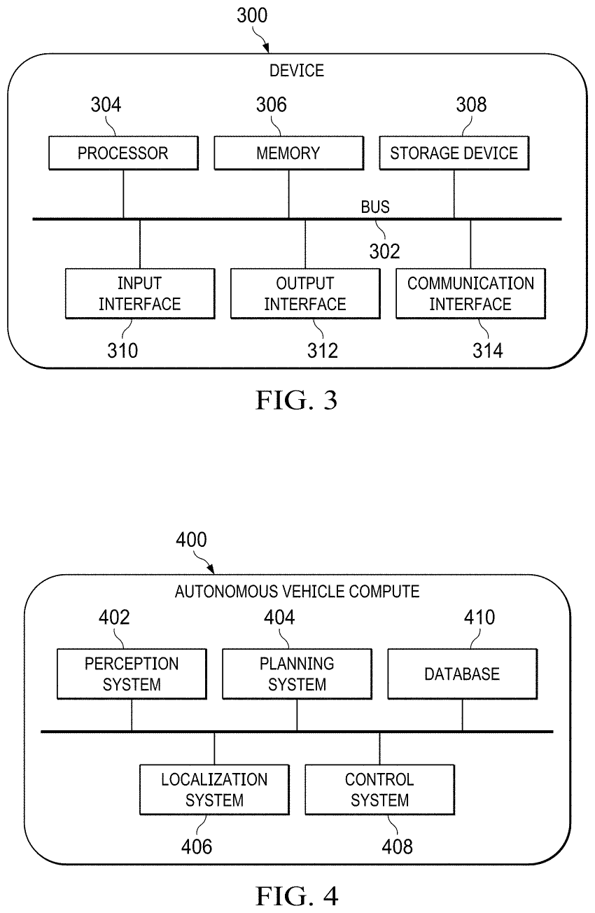

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 2021, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles). In embodiments, communications device 202e can communicate information using radio-wave-based (or over the air) communications protocols with a command center (or remote AV system 114 or similar system) across the network 112. Communication device 202e can include a hardware and software (e.g., protocol stack) to encode packets with information, encrypt packets, and transmit packets over the air, as well as hardware and software to receive encrypted packets, decrypt them, and decode them into usable information.

In some embodiments, the communications device 202e also includes hardware and software to encode, encrypt, and transmit packets into optical waves for transmission across LoS communications links, as well as hardware and software to receive packets, decrypt them, and decode them to access usable information.

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 2021, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

3. Architecture Overview

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

In some example embodiments, vehicles can use embedded LoS communications devices in the headlights and the brake lights to securely exchange information between local vehicles by aligning in specific lane patterns. LoS communications devices can also be embedded in the LiDAR unit, fenders, quarter panels, windshields, or other location of the vehicle without deviating from the scope of the disclosure. The AV compute provides an encrypted data packet that is available within the localized light network. AV connections can be made in the same lane, side-by-side or diagonally. Once authenticated, AVs can interlink to pass data and form adaptive driving patterns or “caravans.” While linked, internal and external HMI can be sequenced to highly visible and accessible patterns meant for clients and road users alike.

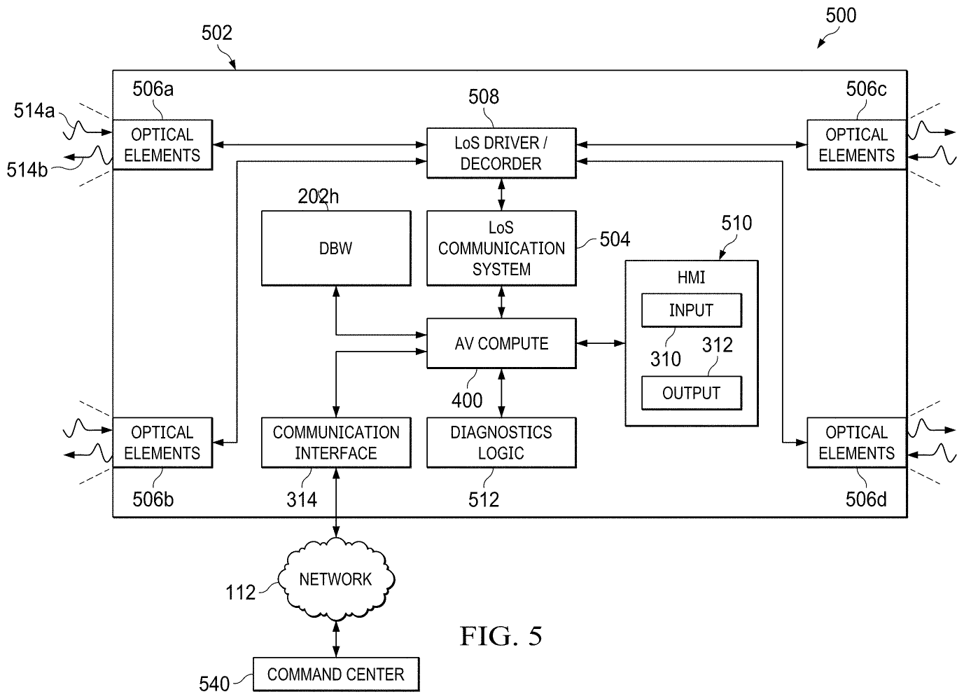

FIG. 5 is a schematic diagram of a vehicle 502 with a Li-Fi communication system 504 in accordance with embodiments of the present disclosure. Vehicle 502 can operate in an environment 500 that includes a network 112 and a command center 540 (which can be similar to remote AV system 114 described above). Vehicle 502 is similar to vehicles 102a—n and vehicle 200 described above. FIG. 5 highlights non-limiting example components that are used in the establishment and use of LoS communications links. For example, vehicle 500 includes an AV compute 400, DBW system 202h, and communications interface 314 (coupled to communications device 202e, not shown). As described in more detail below, the AV compute 400 can include components that can detect other vehicles that are proximate to the vehicle 502 that are compatible with LoS communication. The AV compute 400 can communicate with the DBW 202h to adjust the position/trajectory of the vehicle 502 to move within line-of-sight of the other vehicle to form the LoS communications link.

Vehicle 500 includes an LoS communication system 504. LoS communication system 504 generally includes hardware and software elements to encode/decode packets, encrypt/decrypt packets, and convert electrical signals into optical signals for transmission/reception across an LoS communications link, such as a Li-Fi link or VLC link. In certain implementations, the LoS communications system 504 can use IEEE 802.15.7-based protocols for transmission and reception of light-based communication signals. LoS communication system 504 can include an LoS driver/decoder 508. The LoS communications system 504 can include a digital signal processor DSP that receives data from one or more sources, such as the AV compute 400, and converts the data into a digital signal. DSP can be coupled to the LoS driver/decoder 508, which converts the digital signal into a photonic signal for emission. The LoS driver/decoder 508 can also receive photonic signals and convert the photonic signals into electrical signals for processing by the DSP in the LoS communications system 504.

Vehicle 502 can include one or more optical elements (OE) 506a-d. OEs 506a-d can include components that absorb light 514a and components that emit light 514b. Optical elements 506a-d can include hardware that can convert electrical signals into light (e.g., a light-emitting diode (LED)) and can convert light into electrical signals (e.g., a photodiode). The OE 506a-d can be located at the headlights and taillights of the vehicle, embedded in the fenders or other body panel, located with the LiDAR unit, or situated elsewhere that is conducive to the establishment of LoS communications links with other vehicles. Vehicle 502 shows four OEs 506a-d, but fewer or more OEs can be used based on implementation choices. OEs 506a-d can transmit and receive encrypted data encoded in light on an LoS communications link.

Vehicle 502 also includes a human-to-machine interface (HMI) 510. HMI 510 can include an input interface 310 and output interface 312, as described above. HMI user experiences can be synchronized between vehicles using the LoS communications link. For example, LED strips, passenger displays, games, music, etc. can be synchronized between vehicles through the LoS communications link. In some embodiments, the LoS communications link can create a network (e.g., mesh network or relay network) that includes one or more vehicles.

When two (or more) vehicles are interlinked, the ability to synchronize HMI experiences is facilitated. One vehicle, known as the pace car, can act as the FAS or command center gateway for relaying information to a local network of vehicles. The local network can be similar to a relay network or mesh network. The local network can receive commands from the command center 540 via the network 112 for controlling user experiences (e.g., control LED strips, synchronize passenger displays, talk between vehicles, synchronize gameplay between vehicles, etc.). The local network can also be used to send diagnostics & vehicle state of a localized network to the FAS cloud.

As an example, the HMI commands can include, but are not limited to:

Arrived→Notify when the vehicle arrives;

Departing→Notify when the vehicle departs;

Canceled ride→Notify when the ride is cancelled;

Emergency→Notify when there is an in-cabin emergency;

AV busy→Notify road users the vehicle is in use;

Seat position→Notify passenger which seat is occupied within the AV;

Ham-link→Voice interlink for AVs within a localized network;

Vid-link→Video interlink for Passenger Displays within a localized network;

Game-link→Game interlink for Passenger Displays within a localized network;

Booking→Display rider information within AV network.

Vehicle 502 can also include a diagnostics logic 512. Diagnostics logic can include hardware and/or software for identifying and storing various vital information pertaining to the vehicle for diagnostic reasons. For example, power levels, tire pressure, fluid levels, motor status, etc. can be tracked and stored with diagnostics logic 512. Diagnostic information can be shared between vehicles. Also diagnostic information can be shared from a second vehicle to the first vehicle, and the first vehicle can transmit that diagnostic information to the command center 540 through the network 112.

The vehicle 502 can communicate with a command center 540 through a network 112 using communications interface 314. The command center 540 can include hardware and software elements that can manage individual vehicles, groups of vehicles traveling together (e.g., caravans), or fleets of vehicles. The command center 540 can coordinate routing for vehicles, adjust trajectories, identifying potential stopping locations, track weather, manage user profiles for passengers, update software, track vehicle identification and vital information including vehicle diagnostics, etc.

In some embodiments, the AV compute 400 can include logic that can encode vehicle control information for transmission to other vehicles using the LoS communications system. This gives the vehicle the ability to control other vehicles' driving patterns together simultaneously. In embodiments, trajectory information can be provided to the vehicle 502 from the command center 540, and that trajectory information can relayed to other vehicles. Each vehicle can then derive its own commands for its respective DBW 202h to execute a trajectory.

For example, command center 540 can include a radio-wave-based communication system to transmit information to a vehicle. The radio-wave-based communication system can include hardware and software to encode data packets for transmission on wired and wireless communications protocols, such as cellular protocols. The command center 540 can include a memory for storing instructions and information. The command center 540 can include one or more hardware processors to execute instructions to carry out operations, such as receiving, using the radio-wave-based communication system, an encrypted handshake validation request message from a primary vehicle, the handshake validation request message for a handshake procedure performed by a primary vehicle and a secondary vehicle to form a caravan. The command center can transmit, to a primary vehicle using the radio-wave-based communication system, a handshake validation response message validating the handshake procedure between the primary vehicle and the secondary vehicle, the handshake validation response message facilitating the formation of the caravan.

After a caravan is formed between two or more cars, the command center 540 can send and receive information using network 112 to a first vehicle (or pace car) that acts as a gateway for the other vehicles in the caravan.

4. Architecture Process Flows for Vehicle-to-Vehicle LoS Communications

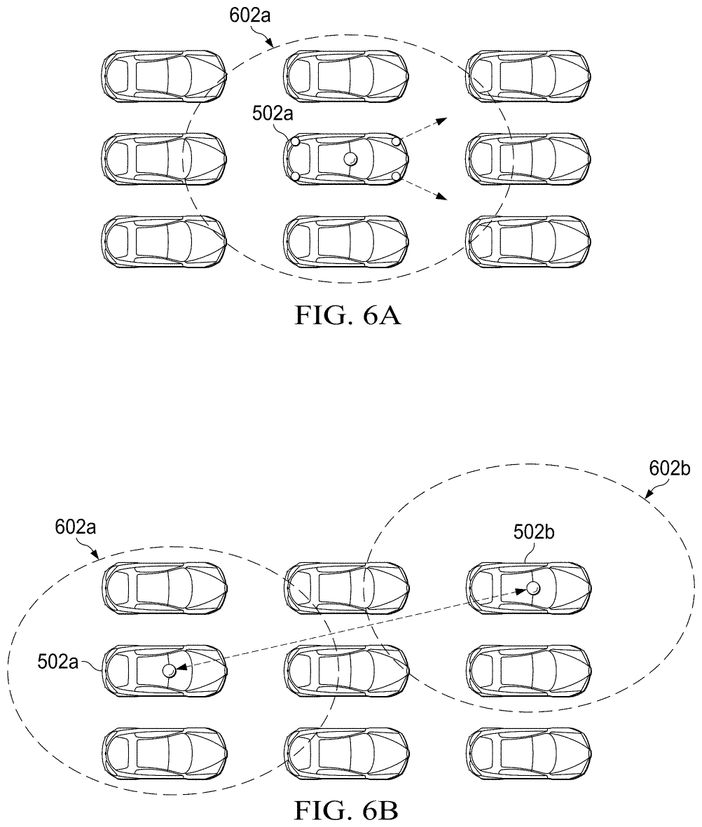

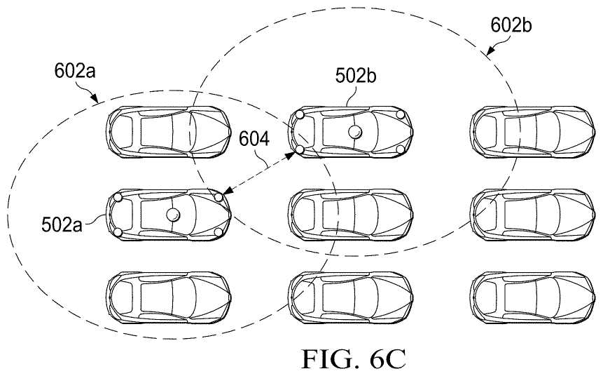

FIGS. 6A-C are schematic diagrams illustrating a first vehicle 502a establishing a line-of-sight (LoS) communications link with a second vehicle 502b in accordance with embodiments of the present disclosure. Vehicle 502a and vehicle 502b are similar to vehicle 102, 200, and 502 described above.

FIG. 6A: a first vehicle 502 actively and/or passively searches for other vehicles that are compatible and amenable (friendly) to form an LoS communications link. The vehicle 502a uses one or more of camera technology (localized observation), GNS technology (global positioning), and LiDAR technology to locate other compatible vehicles. In some embodiments, the first vehicle will not know a second vehicle is friendly until after the handshake and subsequent validation procedure, described below. In some embodiments, the combination of camera, LiDAR, and global positioning information can be used to infer that the vehicle is friendly, based on stored information about a fleet of vehicles, or based on information that is received from the command center about nearby friendly vehicles.

FIG. 6B: the first vehicle 502a locates a second vehicle 502b that is friendly. When two vehicles 502a and 502b observe each other, one or both vehicles can adjust its travel pattern to overlap their circle of observation 602a and 602b, respectively. A circle of observation can be a predetermined distance around the vehicle that establishes a minimum distance for forming an LoS communications link. The circle of observation can also define an area around a vehicle for a geofence.

FIG. 6C: Once the circles of observation 602a and 602b overlap and the vehicles are within a predetermined distance from each other (e.g., a car length of each other (in-front, adjacent, behind, diagonally), the first vehicle 502a uses the LoS communication system to emit an encrypted handshake to the second (friendly) vehicle 502b. After the handshake is sent to the cloud and validated, an LoS data pipeline (LoS communications link) 604 opens that allows data to be exchanged between the vehicles 502a and 502b. At this point, the first vehicle 502a and the second vehicle 502b are part of an LoS network, where the first vehicle is the point of contact between the command center 540 and the other vehicles in the LoS network.

After the data pipeline 604 is open, the first vehicle 502a that initiated the contact can be defined as the pace car. If a caravan is formed, the first vehicle 502a would be the designated leader of a caravan. Or, as put above, the first vehicle 502a becomes a communications gateway between the command center and the other vehicles (502b). The pace car acts as a direct link to the cloud and propagates changes to the localized caravan such as controlling specific car movement as a group and controlling the collective HMI UX experience within the caravan. The defined pace car can be changed based on what car is leading the pack or the caravan “form factor,” described below.

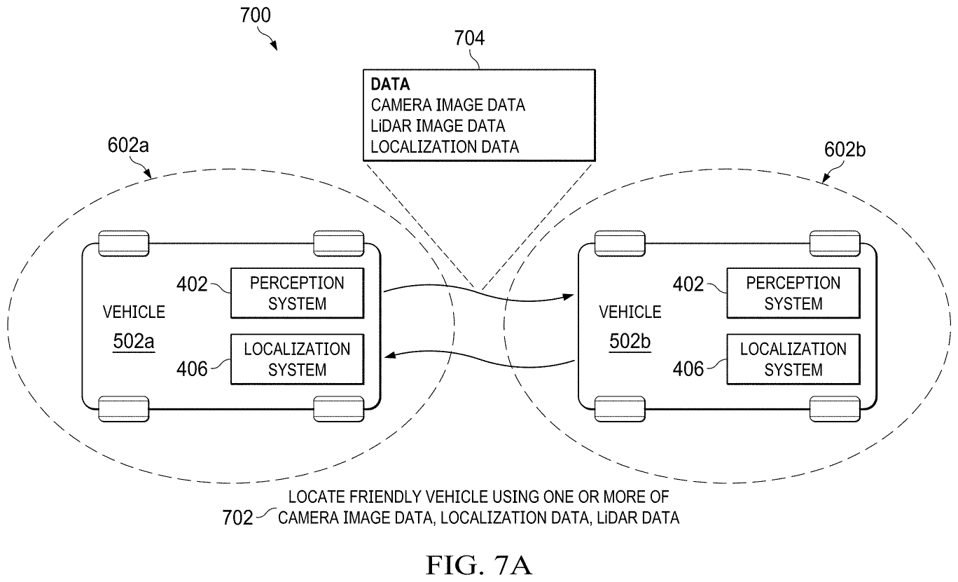

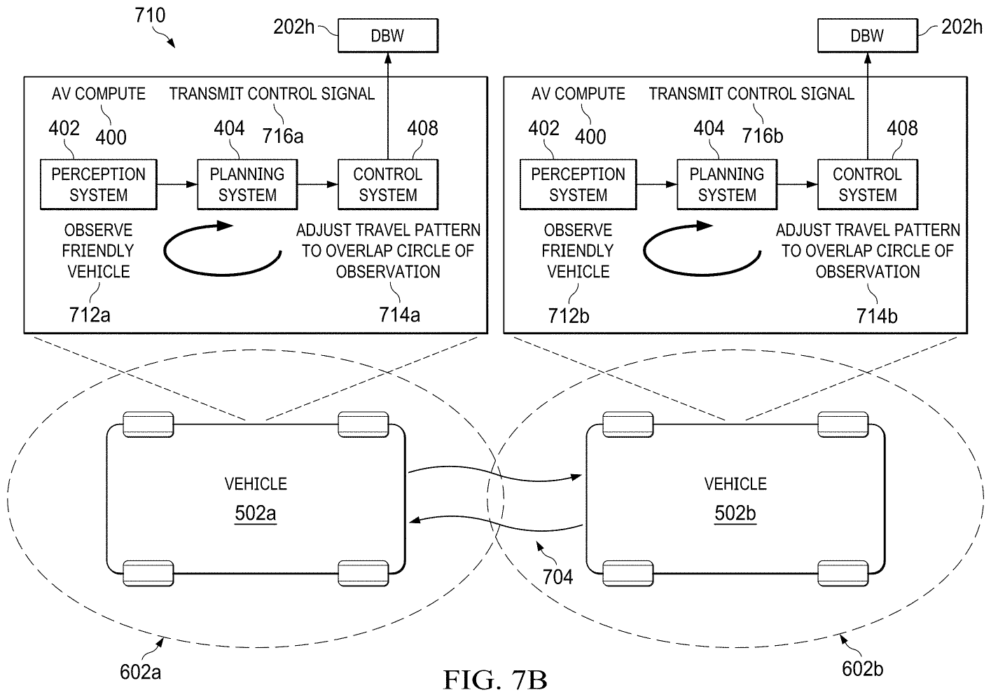

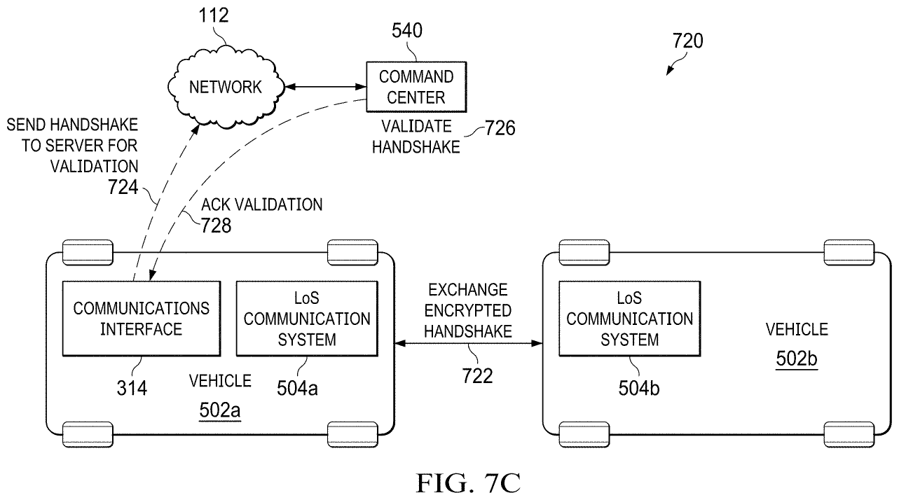

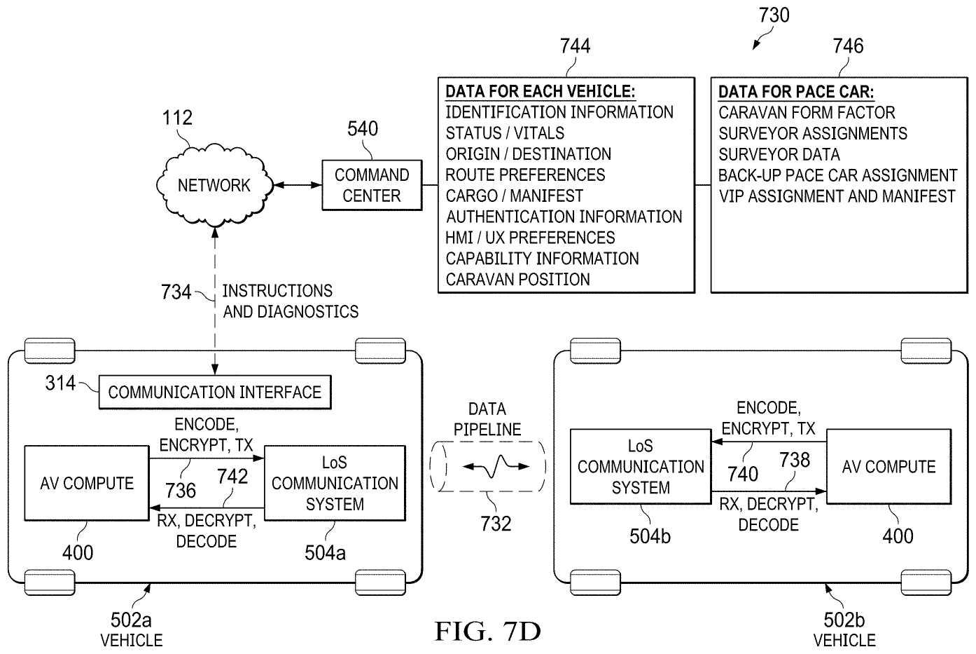

FIGS. 7A-D are diagrams of an implementation of an architectural process for vehicle-to-vehicle Li-Fi communications in accordance with embodiments of the present disclosure.

FIG. 7A is a diagram 700 illustrating two vehicles 502a and 502b are within perception distance from each other but have not yet formed an LoS communications link in accordance with embodiments of the present disclosure. Perception distance can be the distance in which a vehicle can detect another vehicle using one or more devices, such as camera, LiDAR, GNS, etc. FIG. 7A illustrates a vehicle 502a actively or passively searching for a compatible (friendly) vehicle with which to form an LoS communications link. Vehicle 502a continuously receives data 704 from various sources, such as camera sources, LiDAR, global positioning, localization data, and other sources that can indicate to the vehicle 502a that a compatible vehicle 502b is close (vehicle 502b can perform a similar search). Vehicle 502a can use its perception system 402 and localization system 406 to locate a nearby friendly vehicle 502b using one or more data factors 704, including data resulting from camera technology, GNS, and LiDAR (702). Once a friendly vehicle is identified, the vehicle 502a will adjust its trajectory so that its circle of observation 602a overlaps the circle of observation 602b of the friendly vehicle 502b.

FIG. 7B is a schematic diagram 710 of two vehicles adjusting their respective travel patterns so that their circles of observation overlap in accordance with embodiments of the present disclosure. When two vehicles observe each other, they adjust their travel pattern to overlap their circles of observation. To do this, the AV compute 400 uses a combination of components to cause the vehicle to adjust its path. For example, the perception system 402 can observe the location of a friendly vehicle 502b (712a). The planning system 404 can create commands to cause the vehicle 502a to adjust its travel pattern to move the vehicle 502a so that its circle of observation overlaps the friendly vehicle's circle of observation 602b (714a). The planning system 404 can transmit the control signal to the control system 408 (716a). The control system 408 can then command the DBW 202h to execute the commands and move the vehicle 502a.

Likewise, the second vehicle 502b can perform similar operations to move the second vehicle 502b. For example, the perception system 402 can observe the location of a friendly vehicle 502a (712b). The planning system 404 can create commands to cause the vehicle 502b to adjust its travel pattern to move the vehicle 502b so that its circle of observation overlaps the friendly vehicle's circle of observation 602a (714b). The planning system 404 can transmit the control signal to the control system 408 (716b). The control system 408 can then command the DBW 202h to execute the commands and move the vehicle 502b. One or both vehicles can adjust its travel pattern. In some cases, the first vehicle 502a which is going to initiate the LoS communications link is the vehicle that moves. But both vehicles can adjust their travel pattern, depending on the implementation scenario.

FIG. 7C is a schematic diagram 720 of an authentication procedure for establishing the line-of-sight communications link between the first vehicle 502a and the second vehicle 502b in accordance with embodiments of the present disclosure. Once the circles of observation 602a and 602b overlap (and, in some embodiments, the vehicles are within a car length of each other (in-front, adjacent, diagonally, or behind)), the first vehicle 502a (here, the vehicle initiating the LoS communications link) emits an encrypted handshake to the friendly vehicle 502b using the LoS communication system 504a (similar to LoS communication system 504 above) which is received by LoS communications system 504b at the second vehicle 502b (722). The encrypted handshake procedure can do a number of things: first, the handshake procedure begins the process for setting up the vehicles for communication using the LoS communication link; second, the handshake procedure alters the second vehicle 502b that it may be joining a caravan or performing other functions, such as surveyor functions; and third, the handshake procedure provides the first vehicle 502a with information about the second vehicle 502b, such as vehicle identification information and other information, which the first vehicle will transmit to the command center 540 through the network 112.

The first vehicle 502a can receive encrypted handshake information from the second vehicle 502b. The first vehicle 502a can send the encrypted handshake information associated with both the first vehicle 502a and the second vehicle 502b to the command center via network 112 for validation (724). The command center 540 can validate the handshake information (726). For example, if both vehicles are authorized to communicate with each other via the LoS communication link and the command center is authorized to communicate with both of the vehicles, then the command center 540 can validate the handshake. To validate the handshake, the command center 540 can send an acknowledgement (ACK) message to the first vehicle 502a via the network 112 (728). After the handshake is sent to the cloud and validated, a data pipeline opens allowing data to be exchanged between vehicles.

FIG. 7D is a schematic diagram 730 illustrating the established LoS communications link (data pipeline 732) in accordance with embodiments of the present disclosure. The LoS communications link 732 can be a Li-Fi link, VLC link, or other light-based communications link. The first vehicle 502a can use one or more OEs to communicate with the second vehicle using light signals using the data pipeline 732. Data pipeline 732 is an abstraction that represents the establishment of a communications link between the first vehicle and the second vehicle that includes coordinated encoding and decoding schemes, as well as coordinated encryption and decryption schemes.

The first vehicle 502a can communicate with the command center 540 using an over-the-air communications link via the communications interface 314 and network 112. The first vehicle 502a can send and receive various types of information with the command center 540, such as instructions and diagnostics information (734). In some embodiments the received information is processed by the AV compute 400 of the first vehicle prior to packetization. For example, AV compute 400 can derive a driving pattern or other route solution for the second vehicle based on its own perception and planning systems. Or, the information can be sent directly to the LoS communication system 504a for packetization and transmission.

The first vehicle 502a uses its LoS communications system 504a to encode and encrypt data packets for transmission to the second vehicle 502b using light (e.g., light emitted from an optical element, such as an LED) (736). The second vehicle 502b can receive light signals from the first vehicle 502a at a photodiode, for example, and convert light signals into electrical signals, decrypt and decode the signals into information, commands, or other data for the AV compute, HMI, or other component (738). Likewise, the second vehicle 502b can encode and encrypt data packets for transmission to the first vehicle 502a using light (e.g., light emitted from an optical element, such as an LED) (740). The first vehicle 502a can receive light signals from the second vehicle 502b at a photodiode, for example, and convert light signals into electrical signals, decrypt and decode the signals into information, commands, or other data (742).

The type of information 744 that the command center 540 can store and exchange with the first vehicle (and indirectly, other vehicles in the network) include:

1) vehicle identification information—allows command center 540 to know which vehicles are connected in the network. The vehicle identification information can also be used by the command center to identify vehicle capabilities, vehicle preferences, routes, cargo/manifest, authentication information, etc.;

2) vehicle status and vitals—the command center stores vehicle status and vital information, including power levels, air pressure, weight, speed, fluid levels, mileage, or other vital information;

3) origin/destination—the command center 540 can store origin and destination information for each vehicle;

4) route preferences—the command center 540 can store route preferences, such as whether highways are preferable to back roads, whether to avoid tolls, whether speed is preferred over distance, etc.;

5) cargo/manifest information—the command center 540 can store information about what the vehicle is carrying and/or who the vehicle is carrying; if the vehicle is carrying a passenger, then the passenger's preferences can also be stored and relayed to the network;

6) authentication information—the command center 540 can store authentication information to validate vehicles joining the network (e.g., by the handshake procedure described above);

7) HMI/UX preferences—the command center 540 can store HMI and user experience preferences, which the command center 540 can use to synchronize between vehicles, if appropriate;

8) vehicle capability information—the command center 540 can store vehicle capability information, which the command center 540 can use to coordinate performance metrics between the vehicles. For example, if a vehicle has a maximum speed less than other vehicles, this maximum speed can be used as a maximum speed for the vehicles in the network. Vehicle capability information can also be used by the command center 540 for pace car and back-up pace car determinations. For example, if a pace car leaves the network, another vehicle will need to be assigned as the pace car.

9) caravan position information—the command center 540 can store caravan position information so it knows which position each vehicle occupies in the caravan. This can information can be used by the command center 540 for back-up pace car decisions, surveyor assignments, VIP protection assignments, drafting assignments for power conservation, position reassignments for vehicles that are preparing to depart the network, etc. For example, if a vehicle is in a lane away from an exit lane but is due to exit, the command center 540 can cause that vehicle to switch positions with another vehicle to allow the exiting vehicle time to prepare to exit.

This list is an example list and is not meant to be exhaustive.

The command center 540 can also store information 746 for the pace car. For example, the command center can store:

1) caravan form factor information—this information can be used to determine which vehicle can become a pace car, which vehicles are drafting against other vehicles. The form factor information is also used to reestablish the caravan form factor if vehicles join or depart the network.

2) surveyor assignment—if the vehicles are acting as surveyors, the position of each vehicle in the network can be tracked so that survey information can be accumulated and parsed in a useful manner. In addition, each vehicle may have a different type of data it is responsible for collecting: one vehicle may be responsible for traffic pattern data while another is responsible for collecting data on road conditions.

3) surveyor data;

4) back-up pace car assignment—in some cases, the command center 540 can store back-up pace car assignments so that a back-up pace car can be immediately established if the primary pace car departs the network;

5) VIP assignment and manifest—because privacy may be paramount when escorting a VIP, so the pace car can be the only car that has a manifest of the VIP passengers, even if there is a back-up pace car assignment.

The command center 540 can also store other types of data.

At this point the vehicle that initiated the contact (here, first vehicle 502a) is defined as the pace car, which is the point of contact between the command center 540 and the other vehicles in the LoS network. In some use cases, the LoS network can be used to establish a caravan of vehicles, the pace car being the designated leader of a caravan. The pace car, therefore, acts as a direct link to the cloud and propagates changes to the localized caravan such as controlling specific car movement as a group and controlling the collective HMI UX experience within the caravan. The defined pace car can be changed based on what car is leading the pack or the caravan “form factor.”

5. Vehicle Travel Patterns

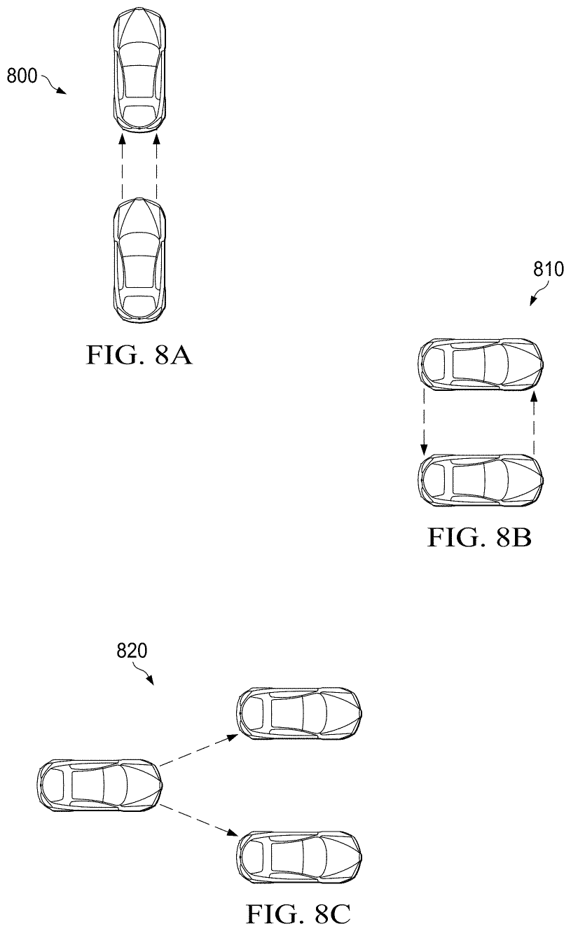

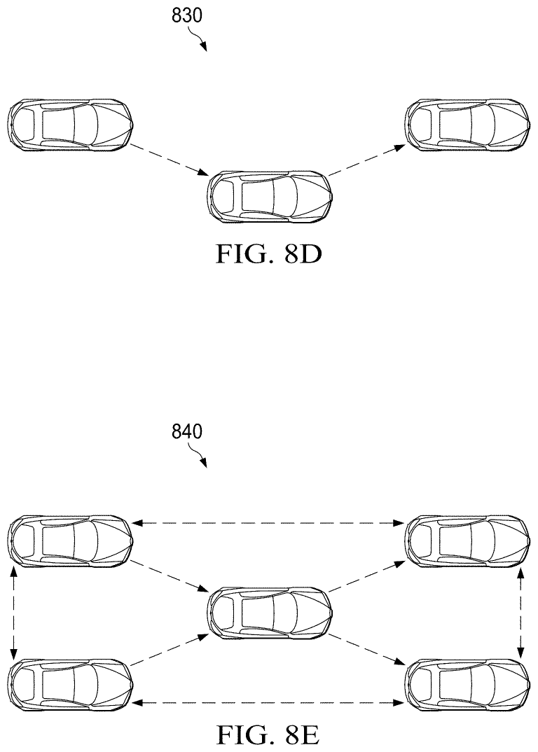

FIGS. 8A-E are diagrams of example caravan patterns in accordance with embodiments of the present disclosure. After a link is established AV driving patterns are synchronized within a local network. A caravan can be defined as a network of vehicles, communicating with each other using the LoS communications links, with synchronized or cooperative driving patterns. The caravan includes a pace car and secondary cars. The vehicles work together as a singular driving unit and can use synchronized HMI features to communicate between vehicles and with road users. The dotted arrows represent the LoS communications link between vehicles. Car Control commands include:

Connect→Establish car interlink

Disconnect→Disconnect car interlink

Ping→Locate cars within a local network

Slow-down→Global slow down

Accelerate→Global acceleration

Emergency brake→Global emergency brake

Group awareness→Utilize AV network cameras to develop awareness within its environment.

FIG. 8A shows an in-line caravan pattern 800. In the in-line caravan pattern, one vehicle is positioned in a line in front (or in back) of another in a single-lane on the road. FIG. 8B shows a side-by-side pattern 810, where two vehicles are adjacent each other occupying adjacent lanes. FIG. 8C shows a branching pattern 820. The branching pattern includes a single vehicle identifying a vehicle in an adjacent lane positioned diagonally away from the single vehicles. The branching pattern 820 can include two or more vehicles. FIG. 8D shows a snake pattern 830. In the snake pattern 830, vehicles can occupy different lanes but maintain larger separation between vehicles in the same lane. FIG. 8E shows a VIP pattern 840, where a VIP car is surrounded by other vehicles in a protection detail.

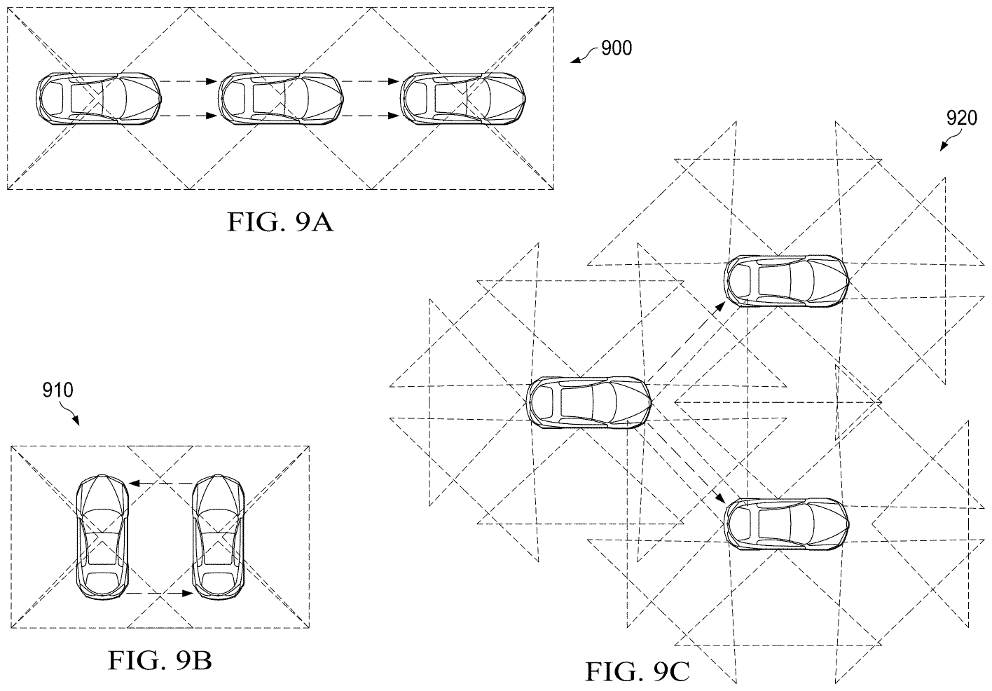

FIGS. 9A-C are diagrams of example surveyor patterns in accordance with embodiments of the present disclosure. The dotted arrows represent the LoS communications link between vehicles. In surveyor mode, vehicles interlink and work together to collect data within a targeted location by using their sensor network to survey their environment in real-time. FIG. 9A shows an in-line surveyor pattern 900. FIG. 9B shows a side-by-side surveyor pattern. FIG. 9C shows a branching surveyor pattern. The triangular blocks illustrate the focus of each vehicles' perception and localization systems for data collection. Surveyor mode can be used for, e.g., documenting traffic patterns and observing and communicating real-time road conditions/alterations (construction, accidents, etc.).

6. Process Flows

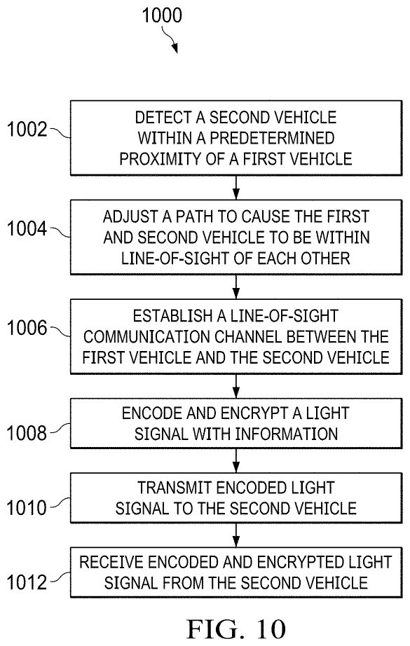

FIG. 10 is a process flow diagram 1000 for a vehicle to establish an LoS communications link with another vehicle in accordance with embodiments of the present disclosure. A first vehicle can actively or passively search for and subsequently detect a second vehicle with which to for a line-of-sight (LoS) communications link (1002). The first vehicle can use camera technology, LiDAR, GNS, or other technology to locate other vehicles for forming the LoS communications link. The first vehicle can adjust its path so that it moves closer to the second vehicle (1004). In some embodiments, both vehicles can adjust their relative positions or just one vehicle can, such as the vehicle that is initiating the LoS communications link. The first vehicle can move so that its circle of observation overlaps the circle of observation of the second vehicle. In some embodiments, the first vehicle moves within a car length of the second vehicle. In some embodiments, the first vehicle moves within line of sight of the second vehicle.

The first vehicle can establish a line-of-sight communications channel with the second vehicle (1006). The first vehicle can do this by first performing a handshake operation using the LoS communication system (e.g., by transmitting encoded light signals to the second vehicle). The handshake can be used to authenticate the vehicles and set up the LoS communications channels and protocols.

Once the LoS communications channel is established, the first vehicle and the second vehicle can exchange information using the LoS communications channel. This can be done by encoding and encrypting a light signal with information (1008) and transmitting the encoded and encrypted light signal using the LoS communications channel (1010). The first vehicle can also receive encoded and encrypted light signals from other vehicles using the LoS communications channel (1012).

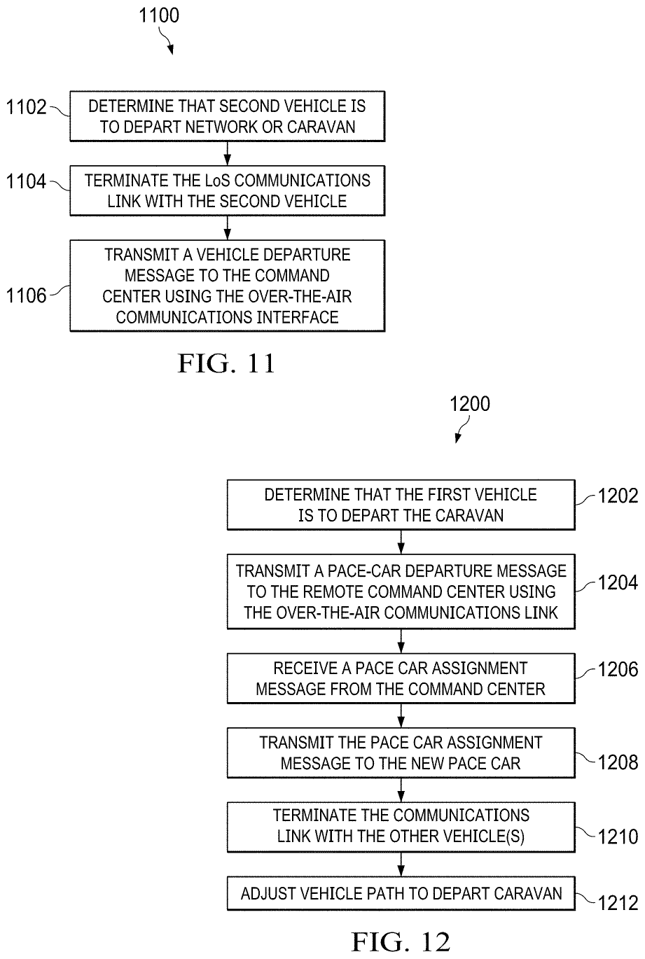

FIG. 11 is a process flow diagram 1100 for a second vehicle to depart a caravan in accordance with embodiments of the present disclosure. The first vehicle can determine that a second vehicle is leaving the network or caravan (1102). The first vehicle can, e.g., receive an indication from the second vehicle that the second vehicle intends to depart the network and terminate the LoS communications link. The first vehicle can then terminate the LoS communications link with the second vehicle (1104). The first vehicle can send a vehicle departure message to the command center via the over-the-air communications link indicating the second vehicle's identification information and an indication that the second vehicle has departed the network or caravan.

In some embodiments, the first vehicle can detect that a second vehicle is moving out of a predetermined radius from the first vehicle. The first vehicle can determine whether the second vehicle is intentionally departing the network or caravan or whether the second vehicle is straying unintentionally. The first vehicle can do this by requesting a departure message from the second vehicle if the LoS communications link is still active (e.g., line of sight is maintained). If the second vehicle acknowledges the departure, then the first vehicle can terminate the LoS communications link and send the indication to the command center, as stated above.

If the second vehicle does not respond or sends a negative acknowledgement in reply to the first vehicle's request for a departure message, the first vehicle can maintain the second vehicle's handshake and set up information, even if the second vehicle loses line of sight. This way, if the second vehicle regains line of sight with the first vehicle, the first vehicle can quickly reestablish the LoS communications link with the second vehicle.

The predetermined radius from the first vehicle can include a distance defining a geofence. If the second vehicle exits the geofence and line of sight is lost, then the first vehicle can maintain the LoS connection handshake authentication and link setup protocols and information for the second vehicle for a predetermined amount of time. If, within the predetermined amount of time, the second vehicle renters the geofence, the timer can be reset, even if the second vehicle has not reestablished line of sight with the first vehicle. If the second vehicle does reestablish line of sight with the first vehicle, the first vehicle can reestablish the LoS communications channel with the second vehicle.

Geofencing can be used for other purposes, as well. For example, if in surveyor mode, a vehicle or other object enters the geofence, the vehicles can be alerted to it and address it. For example, a car may want to pass the caravan, which is occupying multiple lanes. A car that wants to pass can enter the geofence, which signals to the pace car that the caravan pattern needs to be adjusted to allow the car to pass. Once the car departs the geofence, the original caravan pattern can be reestablished, if desired.

FIG. 12 is a process flow diagram 1200 for a pace car to depart a network or a caravan in accordance with embodiments of the present disclosure. In some embodiments, the pace car may wish to depart a network or caravan. The pace car may wish to depart for any number of reasons, such as the route, the power level, other vehicles having priority, etc. The pace car or the command center can determine that the pace car is to depart the network or caravan (1202). The pace car transmit a pace car departure message to the command center using the over-the-air communications link (1204). The pace car can receive from the command center a pace car reassignment message (1206). The pace car reassignment message can include an indication of another vehicle in the network or caravan that is to become the new pace car. In some embodiments, an indication of a back-up pace car is also indicated. The departing pace car can transmit, using the LoS communications link, the pace car assignment to the new pace car (1208). If the new pace car is in line of sight of the departing pace car, the pace car can send this assignment directly to the new pace car. If, however, the new pace car is behind other vehicles in the network or caravan, the departing pace car sends the assignment to an adjacent vehicle in the network, which is to relay that information down the network until it reaches the new pace car.

The departing pace car can terminate the LoS communications link it has with other vehicles (1210) and exit the network/caravan by adjusting its path accordingly (1212).

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

The following examples pertain to further embodiments. Specifics in the examples may be used anywhere in one or more embodiments. All optional features of the apparatus described herein may also be implemented with respect to a method or process.

Example 1 is a method for construction a caravan of vehicles, the method including detecting, using a perception system on a first vehicle operating in an environment a second vehicle operating in the environment; and adjusting, using a control system on the first vehicle, a trajectory of the first vehicle to form a caravan with the second vehicle, wherein adjusting the trajectory of the first vehicle to form the caravan with the second vehicle comprises transmitting data to cause the first vehicle to move to a position such that the second vehicle is within a line-of-sight of at least one line-of-sight communication system of the first vehicle.

Example 2 may include the subject matter of example 1, wherein adjusting the trajectory of the first vehicle to form the caravan with the second vehicle comprises adjusting the trajectory of the first vehicle to move the first vehicle to a position within one car-length of the second vehicle.

Example 3 may include the subject matter of any of examples 1 or 2, further comprising performing, using the line-of-sight communications system, a handshake procedure with the second vehicle and transmitting, using a radio communication system, the results of the handshake procedure to a remote command center for validation.

Example 4 may include the subject matter of any of examples 1-3, further comprising receiving, using the radio communication system, a handshake validation message from the remote command center and establishing, using the line-of-sight communication system, a line-of-sight communications link with the second vehicle.

Example 5 may include the subject matter of any of example 1-4, further comprising receiving, using the radio communication system, information from the remote command center and transmitting, using the line-of-sight communication system, the information to the second vehicle.

Example 6 may include the subject matter of example 5, wherein the information comprises one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

Example 7 may include the subject matter of any of examples 1-6, further comprising synchronizing, using the line-of-sight communication system, a driving pattern of the first vehicle and the second vehicle based on a selected caravan form factor.

Example 8 may include the subject matter of any of examples 1-6, further comprising synchronizing, using the line-of-sight communication system, a human-machine interface (HMI) scheme of the first vehicle and the second vehicle.

Example 9 may include the subject matter of any of examples 1-6, further comprising receiving, using the line-of-sight communication system, traffic pattern information from the second vehicle and transmitting, using the radio communication system, the traffic pattern information to the remote command center.

Example 10 may include the subject matter of any of examples 1-6, further comprising receiving, using the line-of-sight communication system, an indication that the second vehicle is to depart the caravan, terminating the communication link with the second vehicle; and transmitting, using the radio communication system, a vehicle departure message to the remote command system.

Example 11 may include the subject matter of any of examples 1-6, wherein the first vehicle is designated as a pace car for the caravan, the method further comprising determining, using a planning system on the first vehicle, that the first vehicle is to depart the caravan; transmitting, using the radio communication system, a pace car departure message to the remote command center; receiving, using the radio communication system, a pace car assignment message indicating that the second vehicle is to become the pace car; transmitting, using the line-of-sight communication system, the pace car assignment message to the second vehicle; terminating the communication link with the second vehicle; and adjusting, using the control system on the first vehicle, a position of the first vehicle to move the first vehicle out of the caravan.

Example 12 may include the subject matter of any of examples 1-6, wherein the first vehicle is designated as a pace car for the caravan and the second vehicle is designated as a back-up pace car; the method further comprising determining, using a planning system on the first vehicle, that the first vehicle is to depart the caravan; transmitting, using the line-of-sight communication link, a pace car departure message to the back-up pace car that the pace car is going to depart the caravan; transmitting, using the radio communication system, a pace car departure message to the remote command center; terminating the LoS communication link with the back-up pace car; and adjusting, using the control system on the first vehicle, a position of the first vehicle to move the first vehicle out of the caravan.

Example is a first vehicle that includes a perception system to detect a second vehicle, and determine that the second vehicle is compatible with the first vehicle to form a caravan; a control system to move the first vehicle to become within a line-of-sight of the second vehicle; a line-of-sight communication system to establish a line-of-sight communication link with the second vehicle; and a radio communication system to establish a radio communication link with a remote command center; wherein the control system is to adjust the trajectory of the first vehicle to move the first vehicle to a position within one car-length of the second vehicle to form a caravan.

Example 14 may include the subject matter of example 13, wherein the line-of-sight communication system is to transmit a handshake initiation message to the second vehicle, and receive a handshake acknowledgement message from the second vehicle; and the radio communication link is to transmit the results of the handshake procedure to a remote command center for validation.

Example 15 may include the subject matter of any of example 13-14, wherein the radio communication system is to receive a handshake validation message from the remote command center; and the line-of-sight communication system is to establish a communications link with the second vehicle.

Example 16 may include the subject matter of example 15, wherein the radio communication system is to receive information from the remote command center; and the line-of-sight communication system is to transmit the information to the second vehicle.

Example 17 may include the subject matter of example 16, wherein the information comprises one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

Example 18 may include the subject matter of any of examples 13-17, wherein the line-of-sight communication system comprises circuitry to transmit information to the second vehicle to synchronize a driving pattern of the first vehicle and the second vehicle.

Example 19 may include the subject matter of any of examples 13-18, wherein the line-of-sight communication system is to transmit information to the second vehicle to synchronize a human-machine interface (HMI) scheme of the first vehicle and the second vehicle.

Example 20 may include the subject matter of any of examples 13-19, wherein the line-of-sight communication system is to receive traffic pattern information from the second vehicle; and the radio communication system is to transmit the traffic pattern information to the remote command center.

Example 21 may include the subject matter of example 15, wherein the line-of-sight communication system is to receive an indication that the second vehicle is to depart the caravan, and terminate the communication link with the second vehicle; and the radio communication system is to transmit a vehicle departure message to the remote command system.

Example 22 may include the subject matter of example 15, wherein the first vehicle is designated as a pace car for the caravan, the first vehicle comprising a planning system to determine that the first vehicle is to depart the caravan; the radio communication system to transmit a pace car departure message to the remote command center; receive a pace car assignment message indicating that the second vehicle is to become the pace car. The line-of-sight communication system is to transmit the pace car assignment message to the second vehicle, and terminate the communication link with the second vehicle; and the control system to adjust a position of the first vehicle to move the first vehicle out of the caravan.

Example 23 may include the subject matter of any of examples 13-22, wherein the first vehicle is designated as a pace car for the caravan and the second vehicle is designated as a back-up pace car; the first vehicle comprising a planning system to determine that the first vehicle is to depart the caravan; the radio communication system to transmit a pace car departure message to the remote command center; the line-of-sight communication link to transmit a pace car departure message to the back-up pace car that the pace car is going to depart the caravan, and terminating the communication link with the back-up pace car; and the control system to adjust a position of the first vehicle to move the first vehicle out of the caravan.

Example 24 may include the subject matter of any of examples 13-23, wherein the line-of-sight communication system comprises at least one of an optical emitter and receiver, a Li-Fi system, a visual light communications (VLC) system, or an LED.

Example 25 is a vehicle caravan comprising a primary vehicle operating in an environment; and a secondary vehicle operating in the environment. The primary vehicle is proximate the secondary vehicle, the primary vehicle to control a trajectory of the secondary vehicle using a line-of-sight communication system.

Example 26 may include the subject matter of example 25, wherein the primary vehicle is positioned to be in a line-of-sight of the secondary vehicle.

Example 27 may include the subject matter of any of examples 25 or 26, wherein the primary vehicle is positioned within one car length of the secondary vehicle.

Example 28 may include the subject matter of any of examples 25-27, wherein the primary vehicle and the secondary vehicle are in one of a same lane or adjacent lanes.

Example 29 may include the subject matter of any of examples 25-28, wherein the primary vehicle and the secondary vehicle operate using synchronized trajectories.

Example 30 may include the subject matter of any of examples 25-29, wherein the primary vehicle and the secondary vehicle operate using synchronized human-machine interfaces.

Example 31 may include the subject matter of any of examples 25-30, wherein the primary vehicle comprises a radio-wave-based communication system to communicate with a remote command center. The primary vehicle to receive vehicle trajectory information from the remote command center using the radio-wave-based communication system, and transmit vehicle trajectory information to the secondary vehicle using the line-of-sight communication system.

Example 32 may include the subject matter of any of examples 25-31, wherein the line-of-sight communication system comprises at least one of a Li-Fi system, a laser-based communication system, a visual light communication system, a light-emitting diode-based communication system, or line-of-sight communication system.

Example 33 may include the subject matter of any of examples 25-32, wherein the primary vehicle comprises a global positioning system (GPS), and wherein the primary vehicle establishes a geofence around the secondary vehicle using the GPS.

Example 34 may include the subject matter of example 33, wherein the primary vehicle detects a departure of the secondary vehicle based on the secondary vehicle exiting the geofence.

Example 35 may include the subject matter of any of examples 33 or 34, wherein the primary vehicle or the secondary vehicle detects entry of a third vehicle based on the third vehicle entering the geofence.

Example 36 may include the subject matter of any of examples 25-35, wherein the primary vehicle forms a caravan with the secondary vehicle by detecting, using a perception system, the secondary vehicle; determining, using the perception system, that the secondary vehicle is compatible for forming a caravan; positioning, using a control system, the primary vehicle to become within line-of-sight of the secondary vehicle; transmitting, using the line-of-sight communication system, an encrypted handshake message to the secondary vehicle; receiving, using the line-of-sight communication system, a handshake acknowledgement message; transmitting, using a radio-wave-based communication system, a handshake verification request message to a remote command center; receiving, using the radio-wave-based communication system, a handshake verification message from the remote command center; and establishing, using the line-of-sight communication system, a communication link between the primary vehicle and the secondary vehicle.

Example 37 may include the subject matter of any of examples 25-36, wherein the secondary car comprises a perception system to detect objects along a trajectory; the secondary car to transmit, using a line-of-sight communication system, information about perceived objects along the trajectory to the primary vehicle; the primary vehicle to adjust, using a planning system, the trajectory of the primary vehicle or the secondary vehicle or both; and the primary vehicle to transmit, using the line-of-sight communication system, trajectory adjustment information to the secondary vehicle.

Example 38 is a command center system comprising a radio-wave-based communication system to transmit information to a vehicle; memory for storing instructions and information; and one or more hardware processors to execute instructions to carry out operations, the operations comprising receiving, using the radio-wave-based communication system, an encrypted handshake validation request message from a primary vehicle, the handshake validation request message for a handshake procedure performed by a primary vehicle and a secondary vehicle to form a caravan; and transmitting, to a primary vehicle using the radio-wave-based communication system, a handshake validation response message validating the handshake procedure between the primary vehicle and the secondary vehicle, the handshake validation response message facilitating the formation of the caravan.

Example 39 may include the subject matter of example 38, the operations comprising transmitting, to the primary vehicle, using the radio-wave-based communication system, vehicle control information pertaining to the secondary vehicle.

Example 40 may include the subject matter of any of examples 38 or 39, the operations comprising transmitting, to the primary vehicle, using the radio-wave-based communication system, vehicle interface information pertaining to one or both of the primary vehicle or the secondary vehicle.

Example 41 may include the subject matter of any of examples 38-40, the operations comprising receiving, from the primary vehicle, using the radio-wave-based communication system, vehicle diagnostics information pertaining to the secondary vehicle; and transmitting, to the primary vehicle, using the radio-wave-based communication system, vehicle system correction information for the secondary vehicle based on the diagnostic information.

Example 42 may include the subject matter of any of examples 38-41, the operations comprising receiving, from the primary vehicle, using the radio-wave-based communication system, traffic pattern information or roadway obstruction information for a route being traversed by the caravan; determining, using at least one processor, an alternative route information for the caravan based on at least one of the traffic pattern information or the roadway obstruction information; and transmitting, to the primary vehicle, using the radio-wave-based communication system, the alternative route information for the caravan.

What is claimed is:

1. A method comprising:
detecting, using a perception system on a first vehicle operating in an environment, a second vehicle operating in the environment; and
adjusting, using a control system on the first vehicle, a trajectory of the first vehicle to form a caravan with the second vehicle, wherein adjusting the trajectory of the first vehicle to form the caravan with the second vehicle comprises:
transmitting data to cause the first vehicle to move to a position such that the second vehicle is within a line-of-sight of at least one line-of-sight communication system of the first vehicle.

2. The method of claim 1, wherein adjusting the trajectory of the first vehicle to form the caravan with the second vehicle comprises:
adjusting the trajectory of the first vehicle to move the first vehicle to a position within one car-length of the second vehicle.

3. The method of claim 1, further comprising:
performing, using the line-of-sight communications system, a handshake procedure with the second vehicle; and
transmitting, using a radio communication system, the results of the handshake procedure to a remote command center for validation.

4. The method of claim 3, further comprising:
receiving, using the radio communication system, a handshake validation message from the remote command center; and
establishing, using the line-of-sight communication system, a communications link with the second vehicle.

5. The method of claim 4, further comprising:
receiving, using the radio communication system, information from the remote command center; and
transmitting, using the line-of-sight communication system, the information to the second vehicle.

6. The method of claim 5, wherein the information comprises one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

7. The method of claim 4, further comprising synchronizing, using the line-of-sight communication system, a driving pattern of the first vehicle and the second vehicle based on a selected caravan form factor.

8. The method of claim 4, further comprising synchronizing, using the line-of-sight communication system, a human-machine interface (HMI) scheme of the first vehicle and the second vehicle.

9. The method of claim 4, further comprising:
receiving, using the line-of-sight communication system, traffic pattern information from the second vehicle; and
transmitting, using the radio communication system, the traffic pattern information to the remote command center.

10. A first vehicle comprising:
a perception system to:
detect a second vehicle, and
determine that the second vehicle is compatible with the first vehicle to form a caravan;
a control system to move the first vehicle to become within a line-of-sight of the second vehicle;
a line-of-sight communication system to establish a line-of-sight communication link with the second vehicle; and
a radio communication system to establish a radio communication link with a remote command center;
wherein the control system is to adjust the trajectory of the first vehicle to move the first vehicle to a position within one car-length of the second vehicle to form a caravan.

11. The first vehicle of claim 10, wherein:
the line-of-sight communication system is to:
transmit a handshake initiation message to the second vehicle, and
receive a handshake acknowledgement message from the second vehicle; and
the radio communication link is to transmit the results of the handshake procedure to a remote command center for validation.

12. The first vehicle of claim 11, wherein:
the radio communication system is to receive a handshake validation message from the remote command center; and
the line-of-sight communication system is to establish a communications link with the second vehicle.

13. The first vehicle of claim 12, wherein:
the radio communication system is to receive information from the remote command center; and
the line-of-sight communication system is to transmit the information to the second vehicle.

14. The first vehicle of claim 13, wherein the information comprises one or more of information representing a trajectory associated with the first vehicle, information representing a user experience of a user in the first vehicle, information representing vehicle diagnostics of the first vehicle, information representing a state of the first vehicle, or caravan form factor information representing a position of one vehicle relative to another vehicle.

15. The first vehicle of claim 12, wherein the line-of-sight communication system comprises circuitry to transmit information to the second vehicle to synchronize a driving pattern of the first vehicle and the second vehicle.

16. The first vehicle of claim 12, wherein the line-of-sight communication system is to transmit information to the second vehicle to synchronize a human-machine interface (HMI) scheme of the first vehicle and the second vehicle.

17. The first vehicle of claim 12, wherein:
the line-of-sight communication system is to receive traffic pattern information from the second vehicle; and
the radio communication system is to transmit the traffic pattern information to the remote command center.

18. The first vehicle claim 13, wherein the line-of-sight communication system comprises at least one of an optical emitter and receiver, a Li-Fi system, a visual light communications (VLC) system, or an LED.

19. A vehicle caravan comprising:
a primary vehicle operating in an environment; and
a secondary vehicle operating in the environment;
wherein:
the primary vehicle is proximate the secondary vehicle, the primary vehicle to control a trajectory of the secondary vehicle using a line-of-sight communication system.

20. The vehicle caravan of claim 19, wherein:
the primary vehicle comprises a radio-wave-based communication system to communicate with a remote command center; and
the primary vehicle to:
receive vehicle trajectory information from the remote command center using the radio-wave-based communication system, and
transmit vehicle trajectory information to the secondary vehicle using the line-of-sight communication system.
